(19) United States
(12) Patent Application Publication
(10) Pub. No.: US 2016/0244910 A1
(43) Pub. Date: Aug. 25, 2016

(54) PVDF TEXTILE ARTICLE

(71) Applicant: ARKEMA FRANCE, Colombes (FR)

(72) Inventors: Jerome Chauveau, Evreux (FR); Benjamin KECH, Rouen (FR); Guenter SAPPELT, Mettmann Allemagne (DE)

(21) Appl. No.: 15/026,289

(22) PCT Filed: Sep. 30, 2014
(86) PCT No.: PCT/FR2014/052466

§ 371 Date: Mar. 31, 2016

(30) Foreign Application Priority Data
Oct. 4, 2013 (FR) 1359652

(51) Int. Cl. D06M 15/256; D06N 3/04; D06M 23/10; D06N 3/00; B05D 1/02; B05D 1/18

(52) U.S. Cl. CPC D06M 15/256; B05D 1/02; B05D 1/18; D06M 23/10; D06N 3/0006; D06N 3/047; D06N 2201/029

(57) ABSTRACT

The present invention relates to an architectural textile article or protective tarpaulin article based on polyvinylidene fluoride (PVDF), said article comprising a woven reinforcement and a coating. More specifically, the invention relates to a textile article comprising a layer of woven fabric made of PVDF homopolymer fibers, said layer having a first face and a second face, said layer being coated on at least one of its faces thereof with a coating comprising a copolymer of vinylidene fluoride (VDF) and of a fluorinated comonomer.

### FIELD OF THE INVENTION

The present invention relates to an architectural textile article or protective tarpaulin article based on polyvinylidene fluoride (PVDF), said article comprising a woven reinforcement and a coating.

An architectural textile or protective tarpaulin article is a woven or nonwoven fabric intended for the production of various covering or construction elements, for example shelters, mobile structures, textile buildings, partitions, tarpaulins, tents, stands, furnishings, billboards, sun protection, ceilings and blinds.

This type of textile material makes it possible to reduce the weight of the structures, to adapt to the space, light and weather constraints and to meet the requirements of current architecture in terms of freedom of shape, resistance to adverse weather conditions, chemical resistance, durability, and protection against fire and/or UV radiation.

### TECHNICAL BACKGROUND

Polyvinyl chloride (PVC) canvases are known that are renowned for their low weight which makes it possible to design light structures intended in particular for textile facades and stretched ceilings. However, PVC canvases experience a reduction in their mechanical properties over time, due to the phenomenon of exudation of the plasticizers present in the PVC-based formulations.

Poly(ethylene-co-tetrafluoroethylene) (ETFE) is another material used as an architectural textile. Its technical features are in particular the transparency to UV rays, and the resistance to wear and to extreme temperatures. This material is not however sufficiently flexible and light, which limits the number of applications thereof.

Other more flexible architectural textiles are obtained by applying a PVC coating, optionally coated with an acrylic, to a polyester textile. The durability of these materials is however limited.

Document U.S. Pat. No. 8,349,747 describes an architectural textile comprising several segments, each segment comprising a base of expanded ETFE fibers and a PVDF or PTFE coating applied to said fibers. Example 1 from this document describes a composite material formed from an expanded PTFE base, on which a coating, consisting of a copolymer of vinylidene fluoride (VDF) and hexafluoropropene (HFP), was applied by lamination. This VDF-HFP copolymer, sold by Arkema Inc. under the reference Kynar® 3120-10, is a heterogeneous copolymer containing less than 10% by weight of HFP, giving said coating a rigid nature, which makes it unsuitable for certain architectural applications.

Document DE 20 2011 109461 describes a textile composite material intended for protecting the back of a solar cell. Said material comprises a textile backing which may be a layer of fabric, a net fabric, a fabric made of fibers or filaments or else a ribbon, based on a fluoropolymer such as PTFE, a thermoplastic fluoropolymer such as PFA, MFA, FEP, ETFE, PVDF, THV and combinations thereof. Said backing is coated with a THV coating. Said backing is connected to the back of a solar cell by means of an elastic adhesive intermediate layer consisting of a thermoplastic fluoropolymer selected from THV and VDF-based copolymers, or silicone-based copolymers that are melt-processable such as polysiloxanes/polyurea/polyurethane polymers. The examples described in this document show composite structures containing 2 or 3 layers, in which the PTFE backing layer is coated with THV and connected to the solar cell by an intermediate layer made of THV (example 1) or made of polysiloxane-based copolymer (example 3).

The present invention aims to solve the drawbacks of the prior art. With this in mind, one of the objectives of the present invention is to propose an architectural textile in the form of a composite structure: woven base/coating, having a long service life, combined with a good UV resistance and with mechanical properties of the woven backing that are not impaired by the coating.

### SUMMARY OF THE INVENTION

For this purpose, the invention relates, according to a first aspect, to a textile article comprising a fabric layer made of PVDF homopolymer fibers, said layer having a first face and a second face, said layer being coated on at least one of its faces with a coating comprising a copolymer of vinylidene fluoride (VDF) and of a fluorinated comonomer.

According to another aspect, the invention relates to a process for manufacturing said textile article, said process comprising a step of applying, to at least one of the faces of said PVDF homopolymer layer, said coating based on VDF copolymer by a technique selected from coating, spraying or dip-coating/impregnation.

According to yet another aspect, the invention relates to the use of said textile article as an architectural textile, especially as a stretched canvas or as a protective tarpaulin.

### DESCRIPTION OF EMBODIMENTS OF THE INVENTION

The invention in now described in greater detail and nonlimitingly in the description that follows.

The invention proposes to provide a novel composite material capable of being used as an architectural textile. According to a first aspect, one subject of the invention is a textile article comprising a layer consisting of a woven material. This is a woven fabric made with PVDF homopolymer multifilaments having a count ranging from 400 dtex (48 filaments) up to 2380 dtex (96 filaments). These PVDF homopolymer multifilaments give the textile article according to the invention an excellent mechanical strength and also a lightness that is compatible with the use thereof in various architectural applications.

The PVDF homopolymer multifilaments used as woven layer employing for example the product Kynar® 705 sold by the applicant, may be textured and woven according to any type of technology known.

This woven textile is coated with a coating based on a copolymer of vinylidene fluoride and of a fluorinated comonomer. Said fluorinated comonomer may be selected from: vinyl fluoride; trifluoroethylene (VF₃); chlorotrifluoroethylene (CTFE); bromotrifluoroethylene; 1,2-difluoroethylene; tetrafluoroethylene (TFE); hexafluoropropylene (HFP); perfluoro(alkyl vinyl) ethers such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD), tetrafluoropropene, chlorotrifluoropropene; 3,3,3-trifluoropropene; pentafluoropropene; 2-chloro-3,3,3-trifluoropropene; the product of formula CF₂═CFOCF₂CF(CF₃)OCF₂CF₂X wherein X is SO₂F, CO₂H, CH₂OH; CH₂OCN or CH₂OPO₃H; the product of formula CF₂═CFOCF₂CF₂SO₂F; the product of formula F(CF₂)ₙCH₂OCF═CF₂ wherein n is equal to 1, 2, 3, 4 or 5; the product of formula R₁CH₂OCF═CF₂ wherein R₁ is hydrogen or F(CF₂)_{z} and z is equal to 1, 2, 3 or 4; the product of formula R₃OCF=CH₂ wherein R₃ is F(CF₂)_{z} and z is equal to 1, 2, 3 or 4; perfluorobutylethylene (PFBE); fluoroethylenepropylene (FEP); 2-trifluoromethyl-3,3,3-trifluoro-1-propene; 2,3,3,3-tetrafluoropropene or HFO-1234yf; E-1,3,3,3-tetrafluoropropene or HFO-1234zeE; Z-1,3,3,3-tetrafluoropropene or HFO-1234zeZ; 1,1,2,3-tetrafluoropropene or HFO-1234yc; 1,2,3,3-tetrafluoropropene or HFO-1234ye; 1,1,3,3-tetrafluoropropene or HFO-1234zc; chlorotetrafluoropropene or HCFO-1224.

Preferably, the aforementioned fluorinated comonomer is selected from chlorotrifluoroethylene (CTFE), hexafluoropropylene (HFP), trifluoroethylene (VF₃), tetrafluoroethylene (TFE) and mixtures thereof.

The comonomer is advantageously HFP. Preferably the copolymer comprises only VDF and HFP.

According to one preferred embodiment, the VDF/HFP copolymer has an HFP content of greater than 10%, preferably greater than 15%. This makes it possible to reduce the flexural modulus of the coating, which considerably increases the flexibility properties of the textile article according to the invention. VDF/HFP copolymers of this type are for example those sold by the applicant under the name KYNAR® Flex 2500, 2750,2800, 2900, 2950 and under the name Kynar ULTRAFLEX.

According to one embodiment, said copolymer is a statistical copolymer. This type of copolymer has the advantage of having a homogeneous distribution of the comonomer along the vinylidene fluoride chains, unlike “heterogeneous” copolymers, which are characterized by a non-homogeneous distribution of the comonomer along the VDF chains, due to the method of synthesis described by the applicant, for example in document U.S. Pat. No. 6,187,885. The heterogeneous VDF/HFP copolymers described in that document are obtained in two steps, the homopolymerisation of the VDF monomer taking place first, followed subsequently by the polymerization of the VDF with the HFP, resulting in isolated domains richer in comonomer being obtained in the copolymer thus prepared.

According to one embodiment, said coating is applied to a single face of said PVDF homopolymer layer.

According to another embodiment, said coating is applied to both faces of said PVDF homopolymer layer.

In both cases, the thickness of the coating layer per face varies between 20 and 80 microns, preferably between 40 and 60 microns.

According to an embodiment, said coating comprises at least one additive selected from: fire-retardant fillers, conductive fillers, impact modifiers, inorganic heat stabilizers, and organic and inorganic UV stabilizers. The presence of these additives makes it possible to selectively improve certain properties of the coating such as the fire resistance or the resistance to UV radiation and to adverse weather conditions.

According to one embodiment, the textile article according to the invention consists of a fabric layer made of PVDF homopolymer fibers, said layer being coated on at least one of its faces with a coating based on a copolymer of VDF and of a fluorinated comonomer.

According to a second aspect, the invention relates to a process for manufacturing said textile article, said process comprising a step of applying, to at least one of the faces of said PVDF homopolymer layer, said coating based on VDF copolymer by a technique selected from coating, spraying or dip-coating/impregnation. These techniques make it possible to apply the coating both to the surface of the PVDF homopolymer multifilament fibers and between these fibers.

The PVDF copolymer coating could be applied either via an aqueous route, or via a solvent route, with the known solvents of PVDF such as for example those from the family of ketones, of methyl ethyl ketone (MEK) or methyl isobutyl ketone (MIBK) type, those from the family of sulfones of dimethyl sulfoxide (DMSO) type or those from the family of ethers of ethyl acetate, diethyl glycol or diethyl acetate type.

The application of the coating by means of the aforementioned techniques has the advantage of making it possible to easily adjust the thicknesses of the coating and of ensuring a better compatibility between the PVDF fibers and the coating layer(s) due to the chemical nature of the polymers used.

According to another aspect, the invention relates to the use of said textile article as an architectural textile, especially as stretched canvas. Such an article is particularly well-suited to various applications in this field, and has one or more of the following properties:

mechanical properties of the woven fabric that are not impaired by the coating,
good resistance to UV radiation,
good impermeability to water,
good cleanability and good performance in terms of elimination of the biofilm,
good fire resistance,
good weldability,
good tear resistance.

### EXAMPLES

The following example illustrates the invention without limiting it.

### Example 1

### According to the Invention

A textile article according to the invention was prepared from a multifilament woven layer made of PVDF homopolymer (KYNAR® PVDF 705) having a count of 550 dtex (96 filaments). This woven layer was coated with a coating comprising a VDF/HFP copolymer (Kynar Flex® 2500-20) previously dissolved in a mixture of MEK and ethyl acetate. The coating formulation contains the following components (per 100 g):

| | | |
|---|---|---|
| Kynarflex 2501-20 | 5.5 | g, |
| MEK | 25 | g, |
| Ethyl acetate | 5 | g, |
| Acrylic polymer at 40% in MEK | 5.9 | g |

The remainder up to 100 g is made up with solvent (MEK) as a function of the targeted final viscosity and the application technique (coating, spraying or dip-coating/ impregnation). This formulation is deposited by a liquid route on both faces of the woven fabric using a coating-type device.
After evaporation of the solvent (drying in air or for a few minutes at 60° C.), the coating on each face measures around 15 microns and is present between the fibers that make up the fabric. The final thickness of 50 microns was obtained after three successive spraying applications.

1. A textile article comprising a fabric layer made of polyvinylidene fluoride (PVDF) homopolymer fibers, said layer having a first face and a second face, said layer being coated on at least one of its faces with a coating comprising a copolymer of vinylidene fluoride (VDF) and of a fluorinated comonomer.

2. The article as claimed in claim 1, wherein said PVDF homopolymer fibers are multifilaments comprising from 48 to 96 filaments and having a count of between 400 and 2380 dtex.

3. The article as claimed in claim 1, wherein said coating covers both faces of the PVDF homopolymer layer.

4. The article as claimed in claim 1, wherein said copolymer is a statistical copolymer.

5. The article as claimed in claim 1, wherein said fluorinated comonomer is selected from the vinyl fluoride; trifluoroethylene (VF₃); chlorotrifluoroethylene (CTFE); bromotrifluoroethylene: 1,2-difluoroethylene; tetrafluoroethylene (TFE); hexafluoropropylene (HFP); perfluoro(alkyl vinyl) ethers such as perfluoro(methyl vinyl) ether (PMVE), perfluoro(ethyl vinyl) ether (PEVE) and perfluoro(propylvinyl) ether (PPVE); perfluoro(1,3-dioxole); perfluoro(2,2-dimethyl-1,3-dioxole) (PDD), tetrafluoropropene, chlorotrifluoropropene; 3,3,3-trifluoropropene; pentafluoropropene; 2-chloro-3,3,3-trifluoropropene; the product of formula CF₂═CFOCF₂CF(CF₃)OCF₂CF₂X wherein X is SO₂F, CO₂H, CH₂OH; CH₂OCN or CH₂OPO₃H; the product of formula CF₂=CFOCF₂CF₂SO₂F; the product of formula F(CF₂)ₙCH₂OCF═CF₂ wherein n is equal to 1, 2, 3, 4 or 5; the product of formula R₁CH₂OCF═CF₂ wherein R₁ is hydrogen or F(CF₂)_{z} and z is equal to 1, 2, 3 or 4; the product of formula R₃OCF═CH₂ wherein R₃ is F(CF₂)_{z} and z is equal to 1, 2, 3 or 4; perfluorobutylethylene (PFBE); fluoroethylenepropylene (FEP); 2-trifluoromethyl-3,3,3-trifluoro-1-propene; 2,3,3,3-tetrafluoropropene (HFO-1234yf) E1,3,3,3-tetrafluoropropene (HFO-1234zeE) Z1,3,3,3-tetrafluoropropene (HFO-1234zeZ) 1,1,2,3-tetrafluoroptopene (HFO-1234yc) 1,2,3,3-tetrafluoropropene (HFO-1234ye) 1,1,3,3-tetrafluoropropene (HFC-1234zc) chlorotetrafluoropropene (HCFO-1224).

6. The article as claimed in claim 5, wherein said comonomer is HFP.

7. The article as claimed in claim 1, wherein the weight content of said fluorinated comonomer in the copolymer is at least 10%.

8. The article as claimed in claim 1, wherein the thickness of the coating layer per face varies between 20 and 80 micron.

9. The article as claimed in claim 1, wherein said coating comprises at least one additive selected from from the group consisting of: fire-retardant fillers, conductive fillers, impact modifiers, inorganic heat stabilizers, and organic and inorganic UV stabilizers.

10. A process for manufacturing a textile article as claimed in claim 1, comprising a step of applying, to at least one of the faces of said PVDF homopolymer layer, said coating based on VDF copolymer by a technique selected from coating, spraying or dip-coating/impregnation.

11. The process as claimed in claim 10, wherein said coating is applied to the PVDF homopolymer layer via a solvent route with a solvent selected from the group consisting of ketones, methyl ethyl ketone (MEK), methyl isobutyl ketone (MIBK), sulfones, dimethyl sulfoxide (DMSO), ethyl acetate, diethyl glycol, and diethyl acetate.

12. The process as claimed in claim 10, wherein said coating is applied to the PVDF homopolymer layer via an aqueous route.

13. The textile article as claimed in claim 1 wherein said article is an architectural textile.

14. The textile article as claimed in claim 13, wherein said article is a stretched canvas.

15. The textile article as claimed in claim 13, wherein said article is a protective tarpaulin.

16. The article as claimed in claim 8, wherein the thickness of the coating layer per face varies between 40 and 60 microns.
